(19) United States
(12) Patent Application Publication
(10) Pub. No.: US 2010/0202745 A1
(43) Pub. Date: Aug. 12, 2010

(54) Fiber Optic Distribution Device and Fiber Optic Network Including the Same

(76) Inventors: Bartlomiej Sokolowski, Piotrkow Trybunalski (PL); Tomasz Ciechomski, Lowicz (PL); Grzegorz Fabrykowski, Strykow (PL)

Correspondence Address: CORNING INCORPORATED, INTELLECTUAL PROPERTY DEPARTMENT, SP-TI-3-1, CORNING, NY, 14831, US

(21) Appl. No.: 12/700,837

(22) Filed: Feb. 5, 2010

(30) Foreign Application Priority Data
Feb. 6, 2009 (EP) 09001719.5

(51) Int. Cl. G02B 6/00

(52) U.S. Cl. 385/135

(57) ABSTRACT

A fiber optic distribution device, comprising a housing; said housing providing an inlet opening for an fiber optic riser cable or for an fiber optic tether cable and an outlet opening for said fiber optic riser cable or for said fiber optic tether cable, whereby said inlet opening is assigned to a first side wall of the housing and said outlet opening is assigned to a second, opposite first side wall of the housing; said housing having a third side wall extending between said first side wall and said opposite second side wall, whereby outlet openings for fiber optic drop cables and/or adapters for fiber optic connectors being assigned to said third side wall; said housing further having a bottom wall, whereby at least two spaced apart lines of bend radius control elements are assigned to said bottom wall; whereby each line of bend radius control elements runs in parallel to said third side wall; and whereby in the middle between each two adjacent bend radius control elements of the first line there is positioned each one bend radius control element of the second line thereby providing each two guide channels, namely a first guide channel for guiding optical fibers from the third side wall to the first side wall and a second guide channel for guiding optical fibers from the third side wall to the second side wall.

### RELATED APPLICATIONS

This application claims the benefit of EP Application No. 09001719.5 filed Feb. 6, 2009, the entire contents of which are hereby incorporated by reference.

### TECHNICAL FIELD

The patent application relates to a fiber optic distribution device for indoor applications, especially to a floor box. Further on, the patent application relates to a fiber optic network comprising at least one such fiber optic distribution device.

### BACKGROUND

In the world of the ever-increasing need for broadband bandwidth optical cables have become the main part of telecommunication networks. Optical cables can transmit voice signals, data signals and video signals for very long distances with very high speed. Developments of optic telecommunication networks allow the connection of the end user directly to the optical fiber. This kind of network technology known as FTTH technology (fiber to the home) requires extending an “all optical” communication network closer to the subscribers. As a result such telecommunication networks include large number distribution points from a distribution cable to an end user or subscriber.

One of the key parts of the FTTH network is the last mile connection which often is an indoor installation. Different kind of buildings like multi dwelling units and block of flats require complicated cabling systems which might mean that there are many separated cables, each one to connect one subscriber. Installation of many cables which provide the connection between a main distribution point (which usually is located in the basement or in another place of the building) and the end user may cause many problems with routing through the wall or levels of the building. As a result, such installations consume a lot of time and costs.

Another way to provide the connection between the main distribution point and the end user or subscriber is using an optical cable comprising a riser cable with branched off tether cables, whereby the riser cable is to be connected to the main distribution point via a distribution cable, and whereby the tether cables are to be connected to subscribers via a drop cables. The installation of an optical cable comprising a riser cable and branched off tether cables to provide connection between the main distribution point and the subscribers is done by a highly skilled field technician using standard fiber optic distribution devices which results in high costs of installation.

### SUMMARY

Against this background, a novel fiber optic distribution device is provided allowing easy installation in order to reduce costs for installation. Further on, a novel fiber optic network including such fiber optic distribution devices is provided.

A fiber optic distribution device comprises a housing; whereby said housing provides an inlet opening for an fiber optic riser cable or for an fiber optic tether cable and an outlet opening for said fiber optic riser cable or for said fiber optic tether cable, whereby said inlet opening is assigned to a first side wall of the housing and said outlet opening is assigned to a second, opposite first side wall of the housing; whereby said housing comprises a third side wall extending between said first side wall and said opposite second side wall, whereby outlet openings for fiber optic drop cables and/or adapters for fiber optic connectors being assigned to said third side wall; whereby said housing further comprises a bottom wall, whereby at least two spaced apart lines of bend radius control elements are assigned to said bottom wall; whereby each line of bend radius control elements runs generally in parallel to said third side wall; and whereby in the middle between each two adjacent bend radius control elements of the first line there is positioned each one bend radius control element of the second line thereby providing each two guide channels, namely a first guide channel for guiding optical fibers from the third side wall to the first side wall and a second guide channel for guiding optical fibers from the third side wall to the second side wall.

A fiber optic distribution device comprises a housing; whereby said housing provides an inlet opening for an fiber optic riser cable or for an fiber optic tether cable and an outlet opening for said fiber optic riser cable or for said fiber optic tether cable, whereby said inlet opening is assigned to a first side wall of the housing and said outlet opening is assigned to a second, opposite first side wall of the housing; whereby outlet opening for fiber optic drop cables are assigned to said first side wall and to said second side wall; whereby said housing comprises a bottom wall, whereby at least one line of strain relief elements assigned to said bottom wall runs generally in parallel to the each of said first side wall and said second side wall in order to provide strain relief for the drop cables running through the respective outlet openings of the respective side wall in a way that each drop cable can be placed on of a strain relief element and can be fixed at said strain relief element using a cable tie surrounding the respective drop cable and the strain respective relief element; whereby at each side of each of said strain relief element there is positioned a cable tie guide element guiding the cable tie when mounting the respective cable tie at the respective relief element. The fiber optic distribution devices allow an easy installation and the reduction of costs for installation.

A fiber optic network comprises a riser cable; said riser cable comprising a cable jacket surrounding a plurality of optical fiber bundles and a furcation adapter mounted to an end of said riser cable, said furcation adapter splitting out the optical fibers of said riser cable in a way that each of said optical fibers of said riser cable is surrounded by an individual protection tube and that each of said optical fibers of said riser cable can be connected to an optical fiber of a distribution cable; the fiber optic network further comprises at least one first fiber optic distribution device carrying splices in order to connect optical fibers of the riser cable to optical fibers of a drop cable; the fiber optic network further comprises at least one second fiber optic distribution device carrying splices in order to connect optical fibers of a drop cable to optical fibers of a optical network terminal cable running to a subscriber.

### BRIEF DESCRIPTION OF THE DRAWINGS

Exemplary embodiments will be explained in more detail with reference to the drawing, in which:

FIG. 1 shows an exploded view of a preferred embodiment of a fiber optic distribution device;

FIG. 2 shows a detail of the fiber optic distribution device according FIG. 1;

FIG. 3 shows a detail of FIG. 2 together with a drop cable;

FIG. 4 shows an embodiment of a fiber optic network comprising fiber optic distribution devices according FIG. 1;

FIG. 5 shows another embodiment of a fiber optic network comprising fiber optic distribution devices according FIG. 1.

### DETAILED DESCRIPTION

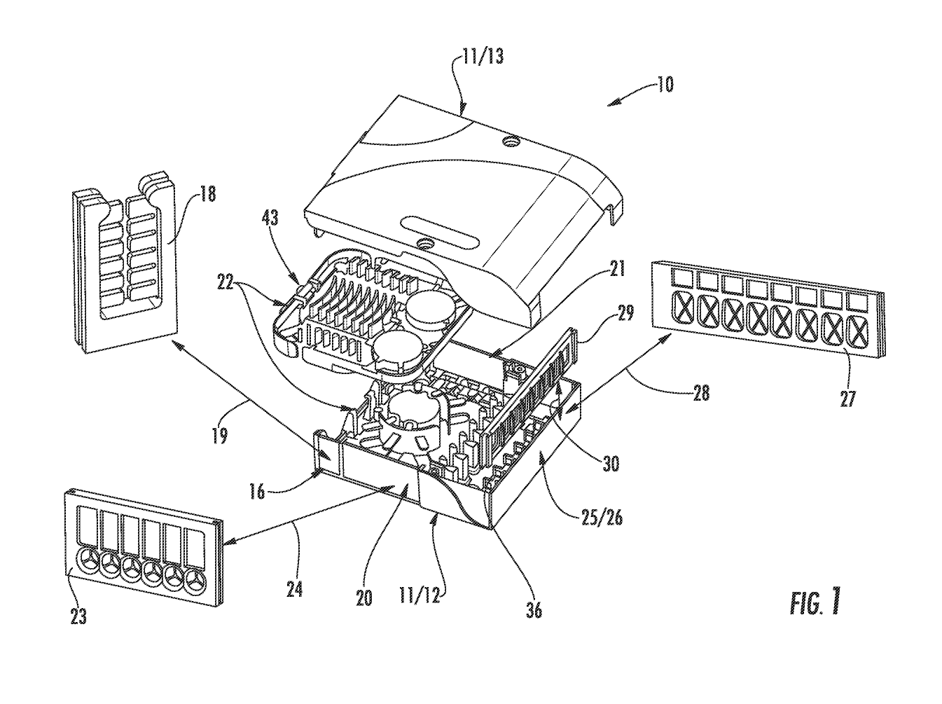

FIGS. 1 to 3 illustrate an exemplary embodiment of a fiber optic distribution device 10 for indoor applications. The fiber optic distribution device 10 comprises a housing 11 having a base part 12 and a cover part 13. The base part 12 and the cover part 13 of the housing 11 define an interior of the housing 11. The base part 12 and the cover part 13 of the housing 11 can be coupled together.

The base part 12 of the housing 11 provides at least one inlet opening for an incoming fiber optic cable entering into the interior of the housing 11 from the exterior of the same and an outlet opening for an outgoing fiber optic cable entering into the exterior of the housing 11 from the interior of the same.

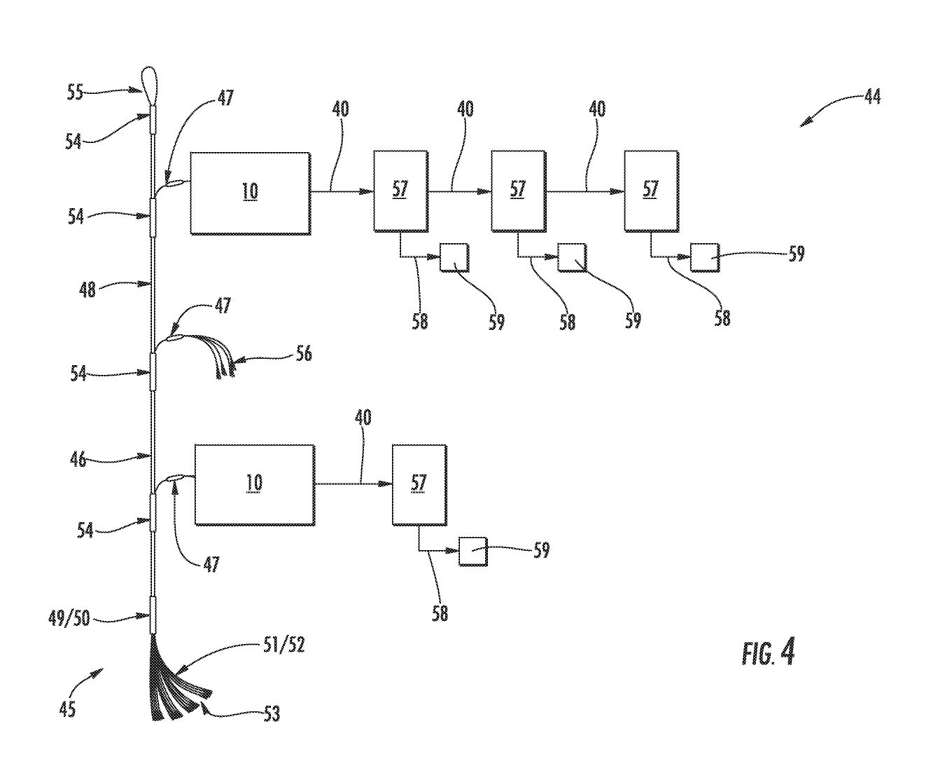

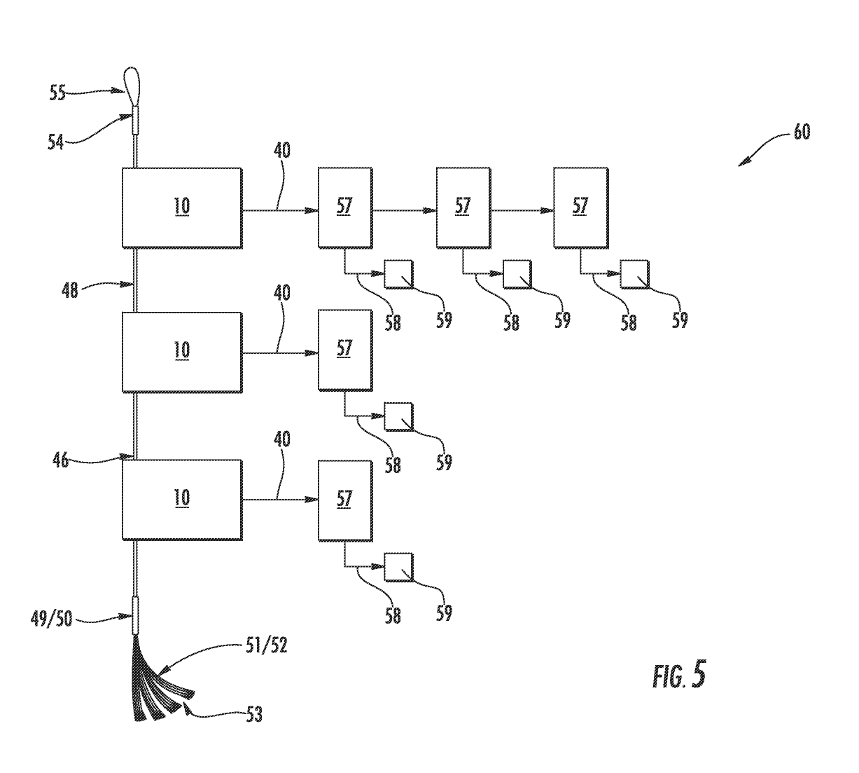

The incoming fiber optic cable and the outgoing fiber optic cable can be a riser cable. Further on, the incoming fiber optic cable and the outgoing fiber optic cable can be a tether cable. The incoming fiber optic cable and the outgoing fiber optic cable are both not shown in FIGS. 1 to 3 but in FIGS. 4 and 5 showing the fiber optic distribution device 10 in connection with embodiments of fiber optic networks. The incoming fiber optic cable and the outgoing fiber optic cable comprise both a number of optical fibers.

The base part 12 of the housing 11 comprises two opposite side walls 14 and 15, namely a first side wall 14 and a second side wall 15. The inlet opening for the riser cable or tether cable is assigned to the first side wall 14 of the base part 12 of the housing 11 and said outlet opening for the riser cable or tether cable is assigned to a second, opposite side wall 15 of the base part 12 of the housing 11.

Said inlet opening for the riser cable or tether cable and said outlet opening for the riser cable or tether cable are prior to installation closed by removable wall sections 16, 17 of the respective side walls 14, 15. During installation these wall sections 16, 17 can be removed and replaced by grommets 18 (see arrow 19 of FIG. 1) defining said inlet opening and said outlet opening.

In addition to the inlet opening for a riser cable or tether cable assigned to the first side wall 14 of the base part 12 of the housing 11 there are outlet openings for fiber optic drop cables assigned to said first side wall 14. In addition to the outlet opening for a riser cable or tether cable assigned to the second side wall 15 of the base part 12 of the housing 11 there are outlet openings for fiber optic drop cables assigned to said second side wall 15. These outlet openings for the drop cables are prior to installation closed by removable wall sections 20, 21 of the respective side walls 14 and 15. These wall sections 20, 21 can be removed and replaced by grommets 23 (see arrow 24 of FIG. 1) during installation defining said outlet openings for the drop cables.

The base part 12 of the housing 11 further comprises a third side wall 25 extending between said first side wall 14 and said opposite second side wall 15. Additional outlet openings for fiber optic drop cables and/or adapters for fiber optic connectors can be assigned to said third side wall 25. Prior installation said third side wall 25 is closed by a removable wall section 26. Said removable wall section 26 can be removed and replaced by a grommet 27 (see arrow 28 of FIG. 1) defining said additional outlet openings for the drop cables or by an adapter frame 29 (see arrow 30 of FIG. 1) defining a holding element for fiber optic adapters receiving fiber optic connectors.

The floor box is usually mounted to a wall. In this case the outlet openings for fiber optic drop cables assigned to said first side wall 14 and said second side wall 15 can be used for vertical drop cables and the outlet openings for fiber optic drop cables assigned to said third side wall 25 can be used for horizontal drop cables.

The base part 12 of the housing 11 further comprises a bottom wall 31, whereby at least two spaced apart lines 32 and 33 of bend radius control elements 34 and 35 are assigned to said bottom wall 31. Each line 32, 33 of bend radius control elements 34, 35 runs generally in parallel to said third side wall 25. The bend radius control elements 34, 35 of the lines 32, 33 are arranged in a way that in the middle between each two adjacent bend radius control elements 34 of the first line 32 there is positioned each one bend radius control element 35 of the second line 33 thereby providing each two guide channels, namely a first guide channel for guiding optical fibers of a drop cable or a pigtail from the third side wall 25 to the first side wall 14 and a second guide channel for guiding such optical fibers from the third side wall 15 to the second side wall 21.

Each bend radius control element 34 of the first line 32 comprises two bend radius control side walls converging in the direction to the second line 33 of bend radius control elements 35. Each bend radius control element 35 of the second line 33 comprises two bend radius control side walls converging in the direction to the first line 32 of bend radius control elements 34.

Strain relief elements are assigned to the bottom wall 31 of the base part 12 of the housing 11, namely first strain relief elements 36 adjacent to the third side wall 25 and second strain relief elements 37 adjacent to the first side wall 14 and to the said second side wall 15. The first strain relief elements 36 provide strain relief for the drop cables or pigtails running to said third side wall 25.

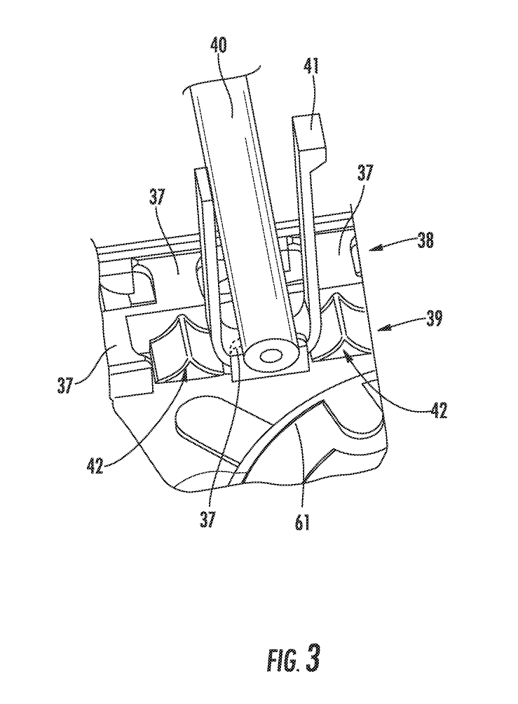

At least one line 38, 39 of second strain relief elements 37 assigned to said bottom wall 31 runs generally in parallel to each of said first side wall 14 and said second side wall 15 in order to provide strain relief for the drop cables running through the respective outlet openings of the respective side wall 14, 15. Each drop cable 40 (see FIG. 3) running through the respective side wall 14, 15 can be placed on such a second strain relief element 37 and can be fixed at said second strain relief element 37 using a cable tie 41 surrounding the respective drop cable 40 and the respective second strain relief element 37. As can be best seen in FIG. 3, at each side of each second strain relief element 37 there is positioned a cable tie guide element 42 guiding the cable tie 41 when mounting the respective cable tie 41 at the respective relief element 37.

According to FIG. 3, two spaced apart lines 38, 39 of second strain relief elements 37 are running generally in parallel to each of said first side wall 14 and said second side wall 15. In the middle between each two adjacent second strain relief elements 37 of the each line 38, 39 there is positioned each one second strain relief element 37 of the respective spaced apart line 39, 38 of second strain relief elements 27. In the middle between each two adjacent cable tie guide elements 42 of the each line 38, 39 there is positioned a cable tie guide element 42 of the respective spaced apart line 39, 38.

According to FIG. 1, the fiber optic distribution device 10 comprises a splice tray 43 being positioned inside the housing 11. The splice tray 43 is swingable attached the housing 11, namely to the base part 12. A hinge 22 is formed between the splice tray 43 and the base part 12 of the housing 11 running generally in parallel to the third side wall 25 of the base part 12.

Depending on the concrete design of the fiber optic network in which the fiber optic distribution device 10 is used, the splice tray 43 can carry at least one splice between an optical fiber of a riser cable and an optical fiber of a pigtail, or at least one splice between an optical fiber of a tether cable and an optical fiber of a pigtail, or at least one splice between an optical fiber of a riser cable and an optical fiber of a drop cable, or at least one splice between an optical fiber of a tether cable and an optical fiber of a drop cable.

It should be noted that the optical fibers of a tether cable could be preconnectorized with fiber optic connectors. In this is case, the optical fibers of the tether cable can be connected to an optical fiber of a drop cable using an adapter being hold by the adapter frame 29 and thereby bypassing the splice tray 43.

FIG. 4 shows a schematic view of a preferred embodiment of a fiber optic network 44 including such fiber optic distribution devices 10. FIG. 4 shows as part of the fiber optic network 44 a cable assembly 45 which comprises a riser cable 46 and tether cables 47 branched off from said riser cable 46.

The riser cable 46 of the fiber optic network 44 comprises a cable jacket 48 surrounding a plurality of optical fiber bundles (not shown), wherein each of said optical fiber bundles comprises preferably a buffer tube surrounding a plurality of individual optical fibers. The riser cable 46 further comprises a furcation adapter 49 mounted to a first end 50 of said riser cable 46, said furcation adapter 49 splitting out individual optical fibers 51 of said riser cable 46 in a way that each of said individual optical fibers 51 of said riser cable 46 is surrounded by an individual protection tube 52 and that each of said individual optical fibers 51 of said riser cable 26 can be connected to an optical fiber of a distribution cable (not shown). The individual optical fibers 51 of said riser cable 46 are preferably connectorized with fiber optic connectors 53 in order to connect each of said individual optical fibers 51 of said riser cable 46 to an optical fiber of said distribution cable.

The riser cable 46 of the fiber optic network 35 further comprises mid span access locations 54, wherein in the region of at least one of these mid span access locations 54 at least one tether cable 47 is branched off from said riser cable 46. According to the embodiment of FIG. 4, the cable assembly 45 comprises three mid span access locations 54, whereby at each mid span access location 54 one tether cable 47 is branched off from said riser cable 46. Each of said tether cables 47 of the cable assembly 36 comprises unspliced optical fibers of said riser cable 46.

The riser cable 46 of the fiber optic network 44 further comprises a pulling member 55 for pulling the riser cable 46 together with the tether cables 47 through a cable duct during installation. The pulling member 55 is assigned to a second end 56 of said riser cable 46. The pulling member 55 is preferably an integral element of the riser cable 46.

The fiber optic network 44 further comprises at least one first fiber optic distribution device 10. The or each first fiber optic distribution device 10 corresponds to the fiber optic distribution device 10 shown in FIGS. 1 to 3.

In the embodiment of a fiber optic network 44 of FIG. 4 a tether cable 47 enters into each first fiber optic distribution device 10. In this case, each first fiber optic distribution device 10 carries connection points to connect optical fibers of a tether cable 47 to optical fibers of a drop cable 40. In case that the optical fibers of a tether cable 47 are preconnectorized with fiber optic connectors 56 (see FIG. 3), the fiber optic connectors 56 of preconnectorized optical fibers of a tether cable 47 can be connected directly with fiber optic connectors of the drop cable 40 using adapters being hold in the adapter frame 29.

Its is also possible to splice the optical fibers of a tether cable 47 to optical fibers of pigtails using the splice tray 43 for storage of the splices and to connect the optical fibers of the pigtails with optical fibers of the drop cable 40 by fiber optic connectors received by adapters being hold in the adapter frame 29. This results in an indirect connection via the pigtail.

Further on, it is possible to splice the optical fibers of a tether cable 47 directly to optical fibers of the drop cable 40 using the splice tray 43 for storage of the splices.

The drop cable 40 emerging from the first fiber optic distribution device 10 enter in a second distribution fiber optic distribution device 57, namely into the second distribution fiber optic distribution device 57 following next to the first fiber optic distribution device 10. Said second fiber optic distribution devices 57 are carrying connection points in order to connect optical fibers of a drop cable 40 to optical fibers of at least one optical network terminal cable 58 each running to a subscriber 59.

The optical fibers of each drop cable 40 are guided to at least one second fiber optic distribution device 57, the or each second fiber optic distribution device 57 carrying splices in order to connect the optical fibers of said drop cable 40 to optical fibers of at least one optical network terminal cable 58 running to a subscriber 59. According to FIG. 4 the optical fibers of the drop cable 40 being connected to the optical fibers of the upper tether cable 47 are guided to a cascade of second fiber optic distribution devices 57, whereby within each second fiber optic distribution devices 57 at least one optical fiber of the drop cable 40 is connected via an optical fiber of a pigtail to an optical fiber of an optical network terminal cable 58. The other optical fibers of the drop cable 40 are uncut and exit the respective second fiber optic distribution devices 57.

FIG. 5 shows a schematic view of another preferred embodiment of a fiber optic network 60 including the fiber optic distribution devices 10. FIG. 5 shows as part of the fiber optic network 44 a riser cable 46 entering directly into the fiber optic distribution devices 10. In this case, each first fiber optic distribution device 10 carries connection points to connect optical fibers of a riser cable 46 to optical fibers of a drop cable 40.

In case that the optical fibers of a riser cable 46 are connectorized with fiber optic connectors, the fiber optic connectors of the connectorized optical fibers of a riser cable 46 can be directly connected with fiber optic connectors of the drop cable 40 using adapters being hold in the adapter frame 29.

Its is also possible to splice the optical fibers of a riser cable 46 to optical fibers of pigtails using the splice tray 43 for storage of the splices and to connect the optical fibers of the pigtails with optical fibers of the drop cable 40 by fiber optic connectors received by adapters being hold in the adapter frame 29. This results in an indirect connection of the optical fibers of a riser cable 46 to optical fibers of the drop cable 40.

Further on, it is possible to connect the optical fibers of a riser cable 46 directly to optical fibers of the drop cable 40.

According to FIG. 5 a cascade of fiber optic distribution devices 10 is assigned to the riser cable 46, whereby within each cascaded fiber optic distribution devices 10 at least one optical fiber of the riser cable 46 is connected to an optical fiber of the drop cable 40. The other optical fibers of the riser cable 46 are uncut and exit the respective fiber optic distribution devices 10.

As described in connection with FIG. 4, the optical fibers of each drop cable 40 of the fiber optic network according to FIG. 5 are guided to at least one second fiber optic distribution device 57, the or each second fiber optic distribution device 57 carrying splices in order to connect the optical fibers of said drop cable 40 to optical fibers of at least one optical network terminal cable 58 running to a subscriber 59.

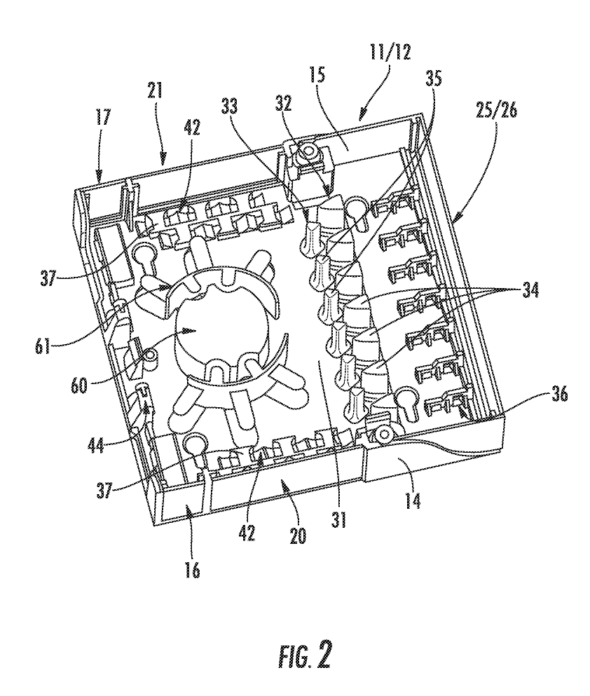

As can be best seen in FIG. 2, two drum-like or cylinder-like optical fiber overlength guiding and storage elements 60 and 61 are assigned to the bottom wall 31 of the base part 12 of the housing 11 of the fiber optic distribution device 10.

The two drum-like or cylinder-like optical fiber overlength guiding and storage elements 60 and 61 are inserted into one another in a way the first fiber overlength guiding and storage element 60 defining a smaller diameter for guiding optical fibers is partly encircled by the second fiber overlength guiding and storage element 61 defining a larger diameter for guiding optical fibers, whereby a first otherlength storage room is provided between the two fiber overlength guiding and storage elements 60 and 61, and whereby a second otherlength storage room is provided radially outside from the second fiber overlength guiding and storage element 61.

The first otherlength storage room provided between the two fiber overlength guiding and storage elements 60 and 61 can preferably be used in the installation of FIG. 5 for the storage of fiber overlength of the riser cable 46 or in the in the installation of FIG. 4 for the storage of fiber overlength of the tether cable 47. The second otherlength storage room provided radially outside from the second fiber overlength guiding and storage element 61 can preferably be used in both installations for the storage of fiber overlength of drop cables or pig tails.

1. A fiber optic distribution device, comprising:
a housing, comprising,
a first side wall having an inlet opening for one of a fiber optic riser cable and a fiber optic tether cable;
a second side wall opposite the first side wall, wherein the second side wall has a outlet opening for one of the fiber optic riser cable and the fiber optic tether cable;
a third side wall extending between the first side wall and the second side wall, wherein the third side wall is configured to have one or both of at least one outlet opening for a fiber optic drop cable and a plurality of fiber optic connector adapters; and
a bottom wall;
a first plurality of bend radius control elements positioned on the bottom wall; and
a second plurality of bend radius control elements positioned on the bottom wall, wherein at least one of the second plurality of bend radius control elements positions such that it aligns with a space between two adjacent ones of the first plurality of bend radius control elements, thereby providing a first guide channel for guiding optical fibers from the third side wall to the first side wall and a second guide channel for guiding optical fibers from the third side wall to the second side wall.

2. The fiber optic distribution device of claim 1, wherein the first side wall has another of at least one outlet opening for the fiber optic drop cable.

3. The fiber optic distribution device of claim 1, wherein the second side wall has another of at least one outlet opening for the fiber optic drop cable.

4. The fiber optic distribution device of claim 1, wherein the first plurality of bend radius control elements is aligned in a first line, and wherein the second plurality of bend control elements is aligned in a second line, and wherein the first line and the second line align generally parallel to the third side wall,

5. The fiber optic distribution device of claim 4, wherein at least one of the first plurality of bend radius control elements comprises two bend radius control side walls converging in the direction of the second line, and wherein at least one of the plurality of second bend radius control elements comprises two bend radius control side walls converging in the direction of the first line.

6. A fiber optic distribution device, comprising:
a housing, comprising,
a first side wall having an inlet opening for one of a fiber optic riser cable and a fiber optic tether cable, and wherein the first side wall has a first fiber optic drop cable outlet opening;
a second side wall opposite the first side wall, wherein the second side wall has an outlet opening for one of the fiber optic riser cable and the fiber optic tether cable, and wherein the second side wall has a second fiber optic drop cable outlet opening;
a bottom wall;
a first plurality of strain relief elements positioned on the bottom wall, wherein one of the first plurality of strain relief elements is configured to provide strain relief for a fiber optic drop cable running through one of the first fiber optic drop cable outlet opening and second fiber optic drop cable outlet opening; and
a first plurality of cable tie guides, wherein ones of the first plurality of cables tie guides are positioned at ones of the first plurality of strain relief elements, and wherein at least one of the first plurality of cable tie guides is adapted to mount a cable tie for fixing the fiber optic drop cable to one of the first plurality of strain relief elements.

7. The fiber optic distribution device of claim 6, wherein the first plurality of strain relief elements and the first plurality of cable tie guides align generally parallel to the first side wall and the second side wall.

8. The fiber optic distribution device of claim 7, further comprising a second plurality of strain relief elements and a second plurality of cable tie guides, wherein ones of the second plurality of cables tie guides are positioned at ones of the second plurality of strain relief element, and wherein the at least one of the second plurality of cable tie guides is adapted to mount a cable tie for fixing the fiber optic drop cable to one of the second plurality of strain relief elements.

9. The fiber optic distribution device of claim 7, wherein the first plurality of strain relief elements is arranged in a first line and the second plurality of strain relief elements is arranged in a second line, wherein the first line and the second line are spaced apart and parallel, and wherein a strain relief element in the first line is positioned such that it aligns between two adjacent strain relief elements in the second line, and wherein a cable guide element positioned by one of the strain relief elements in the first line is positioned such that it aligns between two adjacent cable tie guide elements positioned by two adjacent strain relief elements in the second line.

10. A fiber optic network, comprising:
a riser cable, comprising,
a cable jacket surrounding a plurality of optical fibers;
a furcation adapter mounted to a first end of the riser cable, the furcation adapter splitting out each optical fiber of the plurality of optical fibers of the riser cable in a way that each of the splitted out optical fibers is surrounded by an individual protection tube, wherein each of the splitted out optical fibers can be connected to a respective optical fiber of a distribution cable;
at least one first fiber optic distribution device carrying connection points in order to connect optical fibers of the riser cable to optical fibers of a drop cable; and
at least one second fiber optic distribution device carrying connection points to connect the optical fibers of the drop cable to optical fibers of a optical network terminal cable running to a subscriber.

11. The fiber optic network of claim 10, wherein a second end of the riser cable enters and exits the at least one first fiber optic distribution device.

12. The fiber optic network of claim 11, wherein at least one of the optical fibers of the riser cable passes though the at least one first fiber optic distribution device as an uncut optical fiber.

13. The fiber optic network of claim 11, wherein at least one of the optical fibers of the riser cable is connected inside the at least one first fiber optic distribution device to at least one of the optical fibers of the drop cable.

14. The fiber optic network of claim 13, wherein the at least one optical fiber of the riser cable is connected to the at least one of the optical fibers of the drop cable directly.

15. The fiber optic network of claim 13, wherein the at least one optical fiber of the riser cable is connected to the at least one of the optical fibers of the drop cable indirectly via a pigtail.

16. The fiber optic network of claim 10, wherein the riser cable comprises at least one mid span access location, wherein at the at least one mid span access location a tether cable comprising unspliced optical fibers split off from the riser cable.

17. The fiber optic network of claim 16, wherein the tether cable enters the at least one first fiber optic distribution device; and wherein at least one of the optical fibers of the tether cable connects inside the at least one first fiber optic distribution device to at least one of the optical fibers of the drop cable.

18. The fiber optic network of claim 17, wherein the at least one of the optical fibers of tether cable connects to the at least one of the optical fibers of the drop cable directly.

19. The fiber optic network of claim 17, wherein the at least one of the optical fibers of tether cable connects to the at least one of the optical fibers of the drop cable indirectly via pigtails.

20. A method for distributing fiber optic service in a multiple dwelling unit, comprising the steps of:
providing a fiber optic distribution device having a housing with a first side wall, a second side wall, a third side wall, and a bottom wall, wherein the first side wall has an inlet opening configured for one of a fiber optic riser cable and a fiber optic tether cable, wherein the second side wall has an outlet opening configured for one of a fiber optic riser cable and a fiber optic tether cable, and wherein the third side wall is configured to have one or both of at least one outlet opening for a fiber optic drop cable and a plurality of fiber optic connector adapters;
mounting the fiber optic distribution device in the multiple dwelling unit;
routing a fiber optic riser cable to the fiber optic distribution device, wherein optical fibers of the fiber optic riser cable are optically connected to respective optical fibers of a fiber optic distribution cable;
routing a fiber optic drop cable to the fiber optic distribution device;
optically connecting in the housing one of the optical fibers of the riser cable with an optical fiber of the drop cable, thereby optically connecting the optical fiber of the fiber optic drop cable to one of the optical fibers of the distribution cable through the riser cable;
positioning a first plurality of bend radius control elements on the bottom wall, and
positioning a second plurality of bend radius control elements on the bottom wall, wherein at least one of the second plurality of bend radius control elements positions such that it aligns with a space between two adjacent ones of the first plurality of bend radius control elements, thereby providing a first guide channel for guiding optical fibers from the third side wall to the first side wall and a second guide channel for guiding optical fibers from the third side wall to the second side wall.

21. The method of claim 20, further comprising the steps of:
positioning a first plurality of strain relief elements on the bottom wall, wherein one of the first plurality of strain relief elements is configured to provide strain relief for a fiber optic drop cable running through one of the first fiber optic drop cable outlet opening and second fiber optic drop cable outlet opening; and
positioning a first plurality of cable tie guides, wherein ones of the first plurality of cables tie guides are positioned at ones of the first plurality of strain relief elements, and wherein at least one of the first plurality of cable tie guides is adapted to mount a cable tie for fixing the fiber optic drop cable to one of the first plurality of strain relief elements.

22. The method of claim 21, further comprising the steps of:
positioning a second plurality of strain relief elements on the bottom wall, wherein one of the second plurality of strain relief elements is configured to provide strain relief for a fiber optic drop cable running through one of the first fiber optic drop cable outlet opening and the second fiber optic drop cable outlet opening;
positioning a second plurality of cable tie guides, wherein ones of the second plurality of cables tie guides are positioned at ones of the second plurality of strain relief elements, and wherein at least one of the second plurality of cable tie guides is adapted to mount a cable tie for fixing the fiber optic drop cable to one of the second plurality of strain relief elements.

23. The method of claim 22, wherein the first plurality of strain relief elements is arranged in a first line and the second plurality of strain relief elements is arranged in a second line, wherein the first line and the second line are spaced apart and parallel, and wherein a strain relief element in the first line is positioned such that it aligns between two adjacent strain relief elements in the second line, and wherein a cable guide element positioned by one of the strain relief elements in the first line is positioned such that it aligns between two adjacent cable tie guide elements positioned by two adjacent strain relief elements in the second line.
